(19) United States
(12) Patent Application Publication
(10) Pub. No.: US 2024/0419943 A1
(43) Pub. Date: Dec. 19, 2024

(54) EFFICIENT DATA DISTRIBUTION PRESERVING TRAINING PARADIGM

(71) Applicant: Oracle International Corporation, Redwood Shores, CA (US)

(72) Inventors: Renata Khasanova, Zurich (CH); Aneesh Dahiya, Zurich (CH); Felix Schmidt, Baden-Dattwil (CH)

(21) Appl. No.: 18/209,024

(22) Filed: Jun. 13, 2023

(51) Int. Cl. G06N 3/0455; G06N 3/084

(52) U.S. Cl. CPC G06N 3/0455; G06N 3/084

(57) ABSTRACT

A computer performs deduplication of an original training corpus for maintaining accuracy of accelerated training of a reconstructive or other machine learning (ML) model. Distinct multidimensional points are detected in the original training corpus that contains duplicates. Based on duplicates in the original training corpus, a respective observed frequency of each distinct multidimensional point is increased. In a reconstructive embodiment and based on a particular distinct multidimensional point as input, a reconstruction of the particular distinct multidimensional point is generated by a reconstructive ML model. Based on increasing the observed frequency of the particular distinct multidimensional point, a scaled error of the reconstruction of the particular distinct multidimensional point is increased. Based on the scaled error of the reconstruction of the particular distinct multidimensional point, accuracy of the reconstructive model is increased. In an embodiment, the reconstructive ML model is an artificial neural network that is a denoising autoencoder that detects anomalous database statements.

### FIELD OF THE INVENTION

The present invention relates to machine learning (ML). Herein is training corpus deduplication for maintaining accuracy of accelerated training.

### BACKGROUND

Neural network based machine learning algorithms are widely used in diverse tasks such as computer vision, natural language processing (NLP), and detection of fraud or online intrusion. Such models are usually trained on very large datasets, which often contain huge amount of naturally occurring duplicates, and many or most non-duplicates may contain repetitive parts. For example, machine generated database logs, social networks, web search or technical reports often contain a large proportion of duplicated content. Various data preprocessing steps may also introduce additional repetition in the data. Storage and processing of such repetitive data is very expensive in terms of computational latency, volatile and nonvolatile space, and electricity. However, simple removal of duplicates loses data distribution information that is crucial for some tasks such as anomaly detection or regression.

A further complication is that the state of the art regards a naturally-occurring (e.g. class) imbalance in a data distribution as a cause of overfitting that decreases fitness in some ways. State of the art rebalancing can cause false negatives or false positives. For example, minority (e.g. class) oversampling causes false positives, and majority (e.g. class) under-sampling causes false negatives. The state of the art has minority oversampling that is inversely proportional to minority frequency. Thus the rarer is a minority, the more important is the minority and the more biased is the sampling toward the minority. In other words, rebalancing works against a natural training bias towards learning the most common (i.e. majority) data. Decreased accuracy from rebalancing is worst for unsupervised training.

### BRIEF DESCRIPTION OF THE DRAWINGS

In the drawings:

FIG. 1 is a block diagram that depicts an example computer that deduplicates an original training corpus for maintaining, in a novel way, accuracy of accelerated training of a reconstructive model;

FIG. 2 is a flow diagram that depicts an example computer process that deduplicates an original training corpus for maintaining, in a novel way, accuracy of accelerated training of a reconstructive model;

FIG. 3 is a block diagram that illustrates a computer system upon which an embodiment of the invention may be implemented;

FIG. 4 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present invention relates to machine learning (ML). Herein is training corpus deduplication for maintaining accuracy of accelerated training. This approach may be used to efficiently train an artificial neural network (ANN) on de-duplicated data without loss in quality of the learning algorithm. This approach has been tested for finding anomalies in structured query language (SQL) logs data with significantly lower time and space complexity.

Performing ML tasks on such highly duplicative data results in unnecessary calculations, which makes training more expensive. Moreover, the same data is stored multiple times and therefore utilizes more space.

Unlike naive deduplication, the approach herein more or less fully preserves information about the original data distribution. That is, novel deduplication herein achieves unprecedented fidelity in which training data is not distorted to suit other concerns. This fidelity is based on measuring and recording frequencies of each repeated data item. This approach has novel weighting to compensate for removed duplicates. Herein is assignment of weights based on frequencies of duplicates to give higher weights to frequent duplicates, lower weights to rare duplicates, and lowest weights to singletons (i.e. no duplicate). This is contrary to the weighting strategy of an imbalanced classification task, because the approach herein preserves the original data distribution.

This approach has a streamlined and effective methodology to specially train an ML model based on duplicate data, which is useful in a scenario where the distribution of training data is important and duplicates cannot be naively removed without decreasing the ML model's fitness. The approach herein has a smaller memory footprint and potentially faster model training time. Training acceleration is due to the fact that no additional iteration needs to be performed for duplicates that are already optimized (i.e. learned) by the model. Performing duplication before other computationally intensive preprocessing accelerates feature preparation such as: a) feature extraction from an object such as a record or log message and b) feature encoding into a feature vector.

By a novel objective function that uses a count of duplicates as a scaling factor, this approach has at least the following advantages.
Order(s) of magnitude space savings by corpus deduplication.
Little or no decrease in accuracy.
Two orders of magnitude speedup of all ML pipeline stages (e.g. corpus preparation, corpus information theoretics, or model training) that are downstream of deduplication.
No feature extraction from duplicates for acceleration.

In an embodiment, a computer detects distinct multidimensional points that represent data objects such as records or log messages in an original training corpus that contains duplicates. Based on duplicates in the original training corpus, a respective observed frequency of each distinct multidimensional point is increased. Based on a particular distinct multidimensional point as input, a reconstruction of the particular distinct multidimensional point is generated by a reconstructive machine learning (ML) model. Based on increasing the observed frequency of the particular distinct multidimensional point, a scaled error of the reconstruction of the particular distinct multidimensional point is increased. Based on the scaled error of the reconstruction of the particular distinct multidimensional point, accuracy of the reconstructive ML model is increased. In an embodiment, the reconstructive ML model is an artificial neural network that is a denoising autoencoder that detects anomalous database statements.

### 1.0 Example Computer

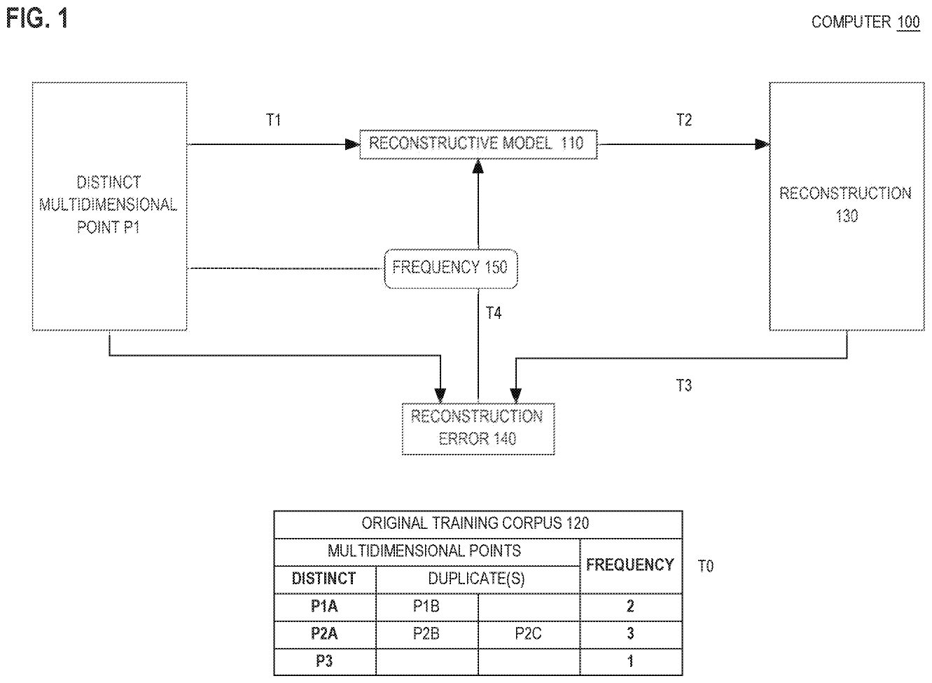

FIG. 1 is a block diagram that depicts an example training computer 100, in an embodiment. For machine learning (ML), computer 100 performs deduplication of original training corpus 120 for maintaining, in a novel way, accuracy of accelerated training of reconstructive model 110 that is stored and operated in computer 100. Computer 100 may be one or more of a rack server such as a blade, a personal computer, a mainframe, a virtual computer, or other computing device.

Reconstructive model 110 is an ML model that may have one of various model functions such as classification or regression. Reconstructive model 110 may have any ML architecture capable of reinforcement learning during training. However as discussed later herein, reconstructive model 100 is not opaque (i.e. black box), and computer 100 trains reconstructive model 110 using an innovative objective function that can integrate with any open source ML library such as scikit-learn.

### 1.1 Distinct and Duplicate Points in Training Corpus

Novel training herein works with any training corpus such as original training corpus 120 that contains six multidimensional points P1A-P1B, P2A-P2C, and P3 that are feature vector instances that each represents a respective instance of a data structure such as a database record, a spreadsheet row, a line of text in a text file, an entry or message in a log, or a semi-structured document such as JavaScript object notation (JSON) or extensible markup language (XML). In some examples, each multidimensional point represents a respective instance of a textual command such as a database statement from which feature values may be extracted.

Each feature (i.e. data field) in original training corpus 120 provides a respective dimension in the multidimensional points. For example, a feature vector may be a one-dimensional array of numeric elements, and each array element may store the numeric encoding of the value of a respective feature.

Original training corpus 120 contains three distinct multidimensional points P1A, P2A, and P3, and all other multidimensional points P1B and P2B-P2C in original training corpus 120 are duplicates of those three distinct multidimensional points. As shown in original training corpus 120, multidimensional point P3 has one distinct instance and no duplicate. Thus as shown in the frequency column of original training corpus 120, the frequency of multidimensional point P3 is one, which is the lowest possible frequency.

As shown in original training corpus 120, multidimensional point P2 has one distinct instance P2A and two duplicate instances P2B-P2C. Thus, the frequency of multidimensional point P2 is three as shown.

### 1.2 Deduplicated Training Corpus

From original training corpus 120, computer 100 generates a deduplicated training corpus that contains only: a) distinct multidimensional points P1-P3, such as P1A, P2A, and P3 as shown in the distinct column and b) the frequencies of the distinct multidimensional points. For example, the deduplicated training corpus may consist of columns shown bold (i.e. the distinct column and the frequency column) from original training corpus 120, but not the duplicate(s) column. In that case, the deduplicated training corpus does not contain multidimensional points P1B and P2B-P2C that are duplicates.

Thus, the deduplicated training corpus is much smaller than original training corpus 120, which conserves space in a training computer that uses the deduplicated training corpus without accessing original training corpus 120. In an embodiment, original training corpus 120 is accessed only at initialization time T0 to: a) detect which multidimensional points in original training corpus 120 are distinct or duplicates, b) populate the frequency column by scanning all multidimensional points in original training corpus 120, and c) generate the deduplicated training corpus from original training corpus 120.

Those (a)-(c) may be performed together in a single pass over all multidimensional points in original training corpus 120 at time T0. After initialization time T0, computer 100 does not access original training corpus 120 and instead uses the deduplicated training corpus. In that case, computer 100 may access the deduplicated training corpus in any of times T1-T4, but does not access original training corpus 120 in times T1-T4.

### 1.3 Error of Reconstruction of Input

Although batch training is discussed later herein, the following demonstrative training iteration entails only one training inference as follows. At time T1, reconstructive model 110 accepts, as input, distinct multidimensional point P1 that is encoded in a feature vector. That input causes reconstructive model 110 to generate and return an inference (not shown) and reconstruction 130 at time T2.

Reconstructive model 110 is a reconstructive model that at time T2 regenerates reconstruction 130 as a new multidimensional point that is an imperfect copy of distinct multidimensional point P1. At time T3, training computer 100 compares multidimensional points P1 and 130 to measure a quantitative difference between multidimensional points P1 and 130, shown as reconstruction error 140 that may quantify reconstruction loss (i.e. how much information from distinct multidimensional point P1 was lost and absent in reconstruction 130). For example, time T3 may measure reconstruction error 140 by: a) multidimensional points P1 and 130 may each be a feature vector that contains a same count of features; b) a respective numeric error may be individually measured for each feature; and c) numeric errors of all features may be arithmetically combined (e.g. summed) to calculate total reconstruction error 140.

The shown embodiment has reconstructive model 110 that causes reconstruction error 140 that is an unsupervised training error that may be measured based on an unlabeled distinct multidimensional point P1 from an unlabeled original training corpus 120. In a supervised embodiment, distinct multidimensional point P1 and original training corpus 120 are labeled, and a supervised ML model is used instead of reconstructive model 110. In that case, a supervised training error is implemented instead of reconstruction error 140. The supervised embodiment does not have reconstruction 130. The supervised embodiment may use any of various loss formulae to measure supervised training error.

The following frequency-based error scaling techniques are agnostic as to: a) whether training is supervised or unsupervised, b) whether original training corpus 120 is labeled or unlabeled, c) whether the ML model is reconstructive or not, d) whether reconstruction 130 is implemented or not, e) whether training error is implemented as reconstruction error or not, and f) the loss function used to measure training loss. The shown embodiment and the following discussion entail reconstruction to demonstrate in a non-limiting way that original training corpus 120 may be unlabeled. If original training corpus 120 is instead labeled, a supervised embodiment of computer 100 is enabled despite substituting comparable components for reconstructive components 110 and 140 and lacking reconstruction 130.

### 1.4 Point Frequency as Novel Scaling Factor for Error

Based on reconstruction error 140, reinforcement learning (e.g. neural backpropagation) occurs at time T4 to increase the accuracy of reconstructive model 110. Reconstruction error 140 is a raw (i.e. unscaled) error that is not directly used as a reinforcement magnitude. Instead, raw reconstruction error 140 is scaled according to the frequency of, in this example, distinct multidimensional point P1 whose frequency 150 is two. For example, scaled error may be calculated by unit linear scaling of reconstruction error 140, in which case the scaled error is calculated by multiplying reconstruction error 140 by two.

The scaled error is used as a reinforcement magnitude such as for backpropagation, which may improve, by adjustment, the internal configuration of reconstructive model 110 to achieve learning. In other words, frequency 150 may operate as a (e.g. linear, unit linear, or non-linear) scaling factor. That means that the numeric value of the scaling factor itself depends on which of distinct multidimensional points P1-P3 is reconstructed and what is the frequency of that distinct multidimensional point.

Training herein is iterative until convergence prevents further significant increase in accuracy of reconstructive model 110 or until a training budget (e.g. time or a count of iterations) is exhausted. In an unbatched embodiment, each iteration has its own one multidimensional point from original training corpus 120 that is input that causes reconstructive model 110 to infer one reconstruction in that iteration.

In a batched embodiment, each training iteration processes a batch of multiple distinct multidimensional points from original training corpus 120. Herein, a batch never contains duplicate multidimensional points and thus is smaller than a state of the art batch and/or more diverse than the state of the art batch. However, such deduplication does not herein bias reinforcement learning toward minority (i.e. infrequent) multidimensional points and, for example, towards minority class(s). Such bias would cause overfitting and decrease the accuracy of reconstructive model 110.

Such bias is avoided by the frequency-based error scaling as discussed earlier herein, which may increase the accuracy of reconstructive model 110 beyond the state of the art for a given training budget (i.e. time, iterations, multidimensional points, or batches). Thus, frequency-based error scaling herein accelerates training while effectively preserving the data distribution in original training corpus 120.

### 2.0 Example Calculation of Feature Weight and Point Weight

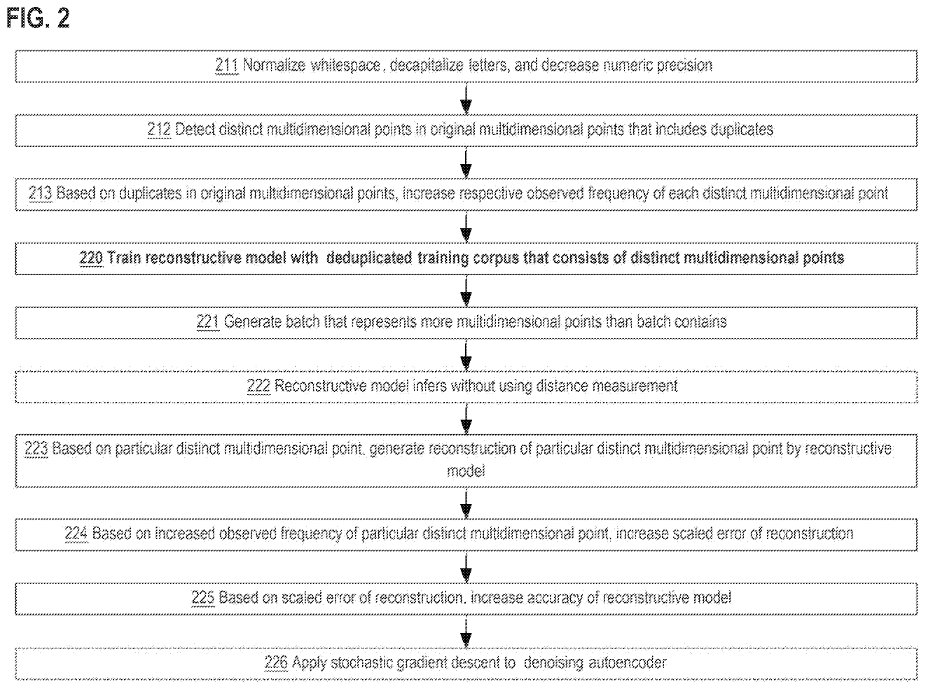

FIG. 2 is a flow diagram that depicts an example process that any computer herein may perform for deduplication of original training corpus 120 for maintaining, in a novel way, accuracy of novel and accelerated training of machine learning (ML) model 110. FIG. 2 is discussed with reference to FIG. 1. The embodiment shown in FIG. 2 is batched, and batching can be effectively avoided by using a batch size of one distinct multidimensional point. Steps 222 and 226 have a dashed outline to indicate that the steps 222 and 226 are for special embodiments and that steps 222 and 226 may be replaced with comparable steps that are, for example, more generalized or as specialized as steps 222 and 226 as discussed later herein. In other words, shown steps 222 and 226 are non-limiting special examples of general activities that occur at those times in the process of FIG. 2.

Corpus preparation steps 211-213 occur at initialization time T0 and cooperate to generate a deduplicated training corpus from original training corpus 120. Data normalization step 211 may perform any of: normalizing whitespace, decapitalizing letters, and decreasing numeric precision. Whitespace normalization may entail replacing multiple adjacent whitespace characters with a single whitespace character and using a predefined universal whitespace character (e.g. a space character) to replace any other whitespace character (e.g. tab or newline). Decreasing numeric precision may entail preserving only a predefined mantissa precision or a predefined count of digits after a decimal point (e.g. period character). Decreasing numeric precision may entail processing of a number that is encoded as binary or text. Decreasing a numeric precision may entail rounding down (i.e. truncation) or up or whichever is nearer to a given number being rounded.

The purpose of data normalization step 211 is to eliminate insignificant (e.g. literal but neither syntactic nor semantic) differences between multidimensional points in original training corpus 120. A result of step 211 is that some multidimensional points that were only slightly and insignificantly different from each other in original training corpus 120 may become identical (i.e. literal duplicates).

Step 212, for example in a single pass over all of the multidimensional points in original training corpus 120, detects duplicates (i.e. duplicate multidimensional points) P1B and P2B-P2C and distinct multidimensional points P1A, P2A, and P3 in original training corpus 120. In other words, step 212 logically separates the multidimensional points into the distinct column and duplicate(s) column shown in original training corpus 120.

Based on detected duplicates, step 213 (e.g. in the same single pass as step 212) increases the respective observed frequency of each distinct multidimensional point. In other words, step 213 uses counting to populate the frequency column shown in original training corpus 120.

Step 220 performs accelerated training of reconstructive model 110 with the deduplicated training corpus that consists of distinct multidimensional points P1A, P2A, and P3 but not duplicates P1B and P2B-P2C. In other words, step 220 uses the deduplicated training corpus instead of original training corpus 120.

The process of FIG. 2 has an initialization phase (i.e. time T0 and steps 211-213) that is model agnostic and does not depend on any knowledge about reconstructive model 110. For example, the initialization phase may occur without knowing: a) the function (e.g. classification or regression) of reconstructive model 110, b) the architecture (e.g. neural or principal component analysis, PCA) of reconstructive model 110, c) the library (e.g. scikit-learn or tensor flow) of reconstructive model 110, nor d) the implementation (e.g. python or Java) of reconstructive model 110. For example, reconstructive model 110 might not be chosen and configured with hyperparameters until after the initialization phase. The initialization phase is future proof and need not recur due to future adoption of a new kind of reconstructive model. That is, the deduplicated training corpus generated by the initialization phase is future proof and can be used as is to train any future kind of reconstructive model.

The initialization phase is followed by a training phase (i.e. times T1-T4 and steps 220-226). Step 220 is shown bold to indicate that it is the boundary between both phases. All steps shown above bold training step 220 are initialization steps. All steps shown below bold training step 220 are training sub-steps of step 220.

Training sub-steps 221 and 225-226 occur exactly once per training iteration that processes one multidimensional point or one batch. Whereas, times T1-T4 and training sub-steps 222-224 occur once or more (e.g. once per distinct multidimensional point in a batch) in each iteration of accelerated training of reconstructive model 110. For example, the training phase of FIG. 2 may implement batched training with an inner loop that processes, in each inner iteration, one distinct multidimensional point in the current batch. The inner loop may be nested in an outer loop that processes a distinct batch in each outer iteration.

Herein, a training iteration may be the outer iteration. Herein, a training iteration is also referred to as an epoch or a training epoch. Herein, an outer sub-step is a sub-step of training step 220 that occurs once in each outer iteration. An inner sub-step is a sub-step of training step 220 that occurs in each inner iteration.

Outer sub-step 221 generates a current batch that represents more multidimensional points than the batch actually contains. Unlike the state of the art, herein a batch never contains a duplicate and instead contains or identifies only distinct multidimensional points that are (e.g. randomly or not) selected from the deduplicated training corpus.

In inner sub-step 222, reconstructive model 110 infers (i.e. generates an inference from an input) without using distance and without measuring distance. For example, nearest neighbor techniques such as KNN and clustering techniques use distance during inferencing and so cannot be used to implement sub-step 222. In that case, reconstructive model 110 should not be based on clustering or KNN.

Inner sub-step 222 is shown with a dashed outline to indicate that sub-step 222 should be implemented only for embodiments in which reconstructive model 110 lacks clustering and KNN. If reconstructive model 110 does use distance during inferencing, then an alternate embodiment of the process of FIG. 2 may implement, instead of sub-step 222, a different inner sub-step in which reconstructive model 110 generates an inference by using or measuring distance such as with clustering or KNN. The alternate embodiment and the shown embodiment are otherwise identical and perform the other steps of FIG. 2 in a same way.

Based on current distinct multidimensional point P1 in the current batch, reconstructive model 110 generates reconstruction 130 in inner sub-step 223 as discussed earlier herein.

Based on the increased (i.e. incremented or otherwise counted) observed frequency (as tallied by initialization step 213) of current distinct multidimensional point P1, inner sub-step 224 increases (i.e. upscales) the scaled error of reconstruction 130. For example, the scaled error may be a multiplicative product, and sub-step 224 may multiply reconstruction error 140 by frequency 150 as a scaling factor as discussed earlier herein.

After inner iterating ceases: inner sub-steps 222-224 had occurred one or more times; and the current outer iteration may resume. If inner sub-step 224 occurred multiple times for one batch of one outer iteration, then sub-step 224 calculated multiple scaled errors respectively for multiple distinct multidimensional points in the current batch.

Based on the scaled error of reconstruction 130, outer sub-step 225 increases the accuracy of reconstructive model 110. Sub-step 225 may perform reinforcement learning as described elsewhere herein such as neural backpropagation.

Outer sub-step 226 is a sub-step of reinforcement sub-step 225. Outer sub-step 226 is shown with a dashed outline to indicate that sub-step 226 should be implemented only for embodiments in which reconstructive model 110 is a denoising autoencoder. Typically reconstructive model 110 has two multidimensional points per inference: distinct multidimensional point P1 and reconstruction 130.

A denoising autoencoder instead has three multidimensional points per inference: a) in original training corpus 120, a distinct multidimensional point that is not used as input to reconstructive model 110, b) accepted by reconstructive model 110 as input at time T1, an (e.g. randomly) imperfect copy of that distinct multidimensional point, and c) reconstruction 130 that reconstructive model 110 learns to generate to be more similar to the original distinct multidimensional point (a) than to the imperfect copy (b) that is actually accepted as input by reconstructive model 110. In other words, a denoising autoencoder does not use actually accepted input for measuring reconstruction loss, which is extraordinary for a reconstructive model.

Stochastic gradient descent (SGD) uses batches of randomly selected distinct multidimensional points from original training corpus 120. Random batches better avoids local optima to find a global optimum.

Sub-step 226 applies stochastic gradient descent to a denoising autoencoder. If reconstructive model 110 is not a denoising autoencoder, then an alternate embodiment of the process of FIG. 2 may implement, instead of sub-step 226, a different outer sub-step in which reconstructive model 110 is batch trained with SGD but without a denoising autoencoder and its imperfect copies as input as discussed above. If reconstructive model 110 is not trained by SGD, then an alternate embodiment of the process of FIG. 2 may implement, instead of sub-step 226, a different outer sub-step in which reconstructive model 110 is batch trained without SGD or trained without batching. Embodiments that implement a different training sub-step instead of sub-step 226 are otherwise identical to the shown embodiment and perform the other steps of FIG. 2 in a same way.

### 3.0 Exemplary Embodiment

Here is a non-limiting exemplary embodiment of the process of FIG. 2. Reconstructive model 110 is an anomaly detector. Each multidimensional point in original training corpus 120 represents a respective structured query language (SQL) statement. Original training corpus 120 contains multidimensional points for over a million anonymized SQL statements that occurred during multiple days. Less than one percent of the multidimensional points in original training corpus 120 are distinct.

Reconstructive model 110 is a denoising autoencoder that is an artificial neural network. The denoising autoencoder consists of a neural encoder and a neural decoder. At time T1, the neural encoder maps distinct multidimensional point P1 to a vector in a latent space, and the decoder generates reconstruction 130 from the latent space vector at time T2.

Reinforcement learning uses neural backpropagation during stochastic (i.e. randomly batched) gradient descent (SGD) for thirty epochs over the entire training dataset as discussed earlier herein. The following is a novel example reconstruction loss formula that is batched and frequency-scaled. As explained earlier herein, a supervised embodiment has a supervised training loss instead of an unsupervised reconstruction loss. The supervised embodiment has a different loss function L that may accept different arguments. Terms B, i, and k and their shown use for division, summation, and multiplication are agnostic as to whether an embodiment is supervised or reconstructive (i.e. unsupervised). In other words, the following reconstruction loss formula may be readily adapted for use as a supervised loss formula.

$$\frac{1}{B} {\sum }_{i}^{B} {k}_{i} L ( {\hat{y}}_{i} , {y}_{i} )$$

The following terms in the above novel example reconstruction loss formula have the following meanings.
B is fixed batch size (i.e. count of distinct multidimensional points in each batch).
i is the distinct ordinal (i.e. identifier) of the current batch.
yᵢ is a distinct multidimensional point in original training corpus 120 from which an imperfect copy was made as input.
ŷᵢ is reconstruction 130.
L is a loss function that measures raw (i.e. unscaled) reconstruction error 140.
kᵢ is frequency 150.

Thus, the above reconstruction loss is frequency scaled in a novel way. By summation and division, scaled reconstruction loss of a batch is calculated as the frequency-weighted average scaled reconstruction loss of the distinct multidimensional points in the batch.

Open source TensorFlow library provides an untrained instance of reconstructive model 110. Open source Adam performs optimized neural backpropagation for accelerated training without decreased accuracy.

The deduplicated training corpus is one percent of the size (i.e. count of multidimensional points) of original training corpus 120, which facilitates running more epochs in less time for accelerated training without decreased accuracy. Training speedup and feature-vector generation speedup are each 100× (i.e. 10,000 percent) and require 99 percent less space for the deduplicated training corpus. Frequency calculation complexity is negligible relative to SQL-statement feature extraction that might entail parsing text to generate a parse tree. Tree structures are notoriously fragmented (i.e. decelerated by pointer chasing and lack of data locality).

For validation (i.e. testing) but not training, the anomaly detection fitness is quantitatively measured as a fitness metric by empirical evaluation and by normalized discounted cumulative gain (nDCG) that in the state of the art was used in an unrelated way to compare recommendation engines based on the idea that highly relevant documents are more useful than moderately relevant documents, which are in turn more useful than irrelevant documents. In terms of anomalies, malicious and high-risk anomalies are more important than low-risk ones. This validation fitness metric is higher if the anomalous SQL statements are ranked higher in comparison to normal activity. For example, each distinct (i.e. without duplicates) SQL statement may have its own predefined (e.g. manually assigned) numeric risk weight that measures the importance of the distinct SQL statement. This risk weight is not frequency 150.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

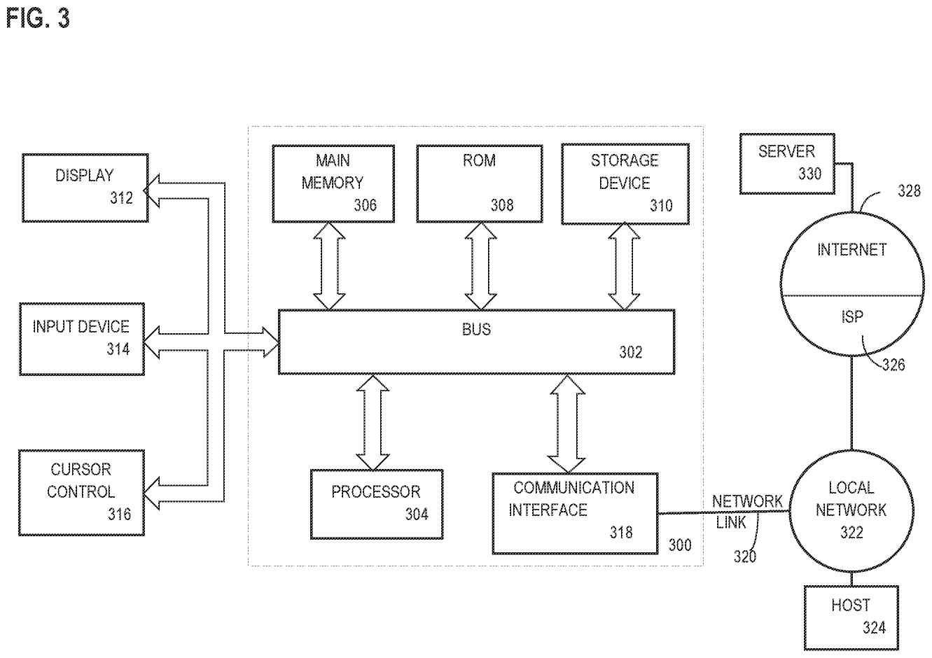

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

### Software Overview

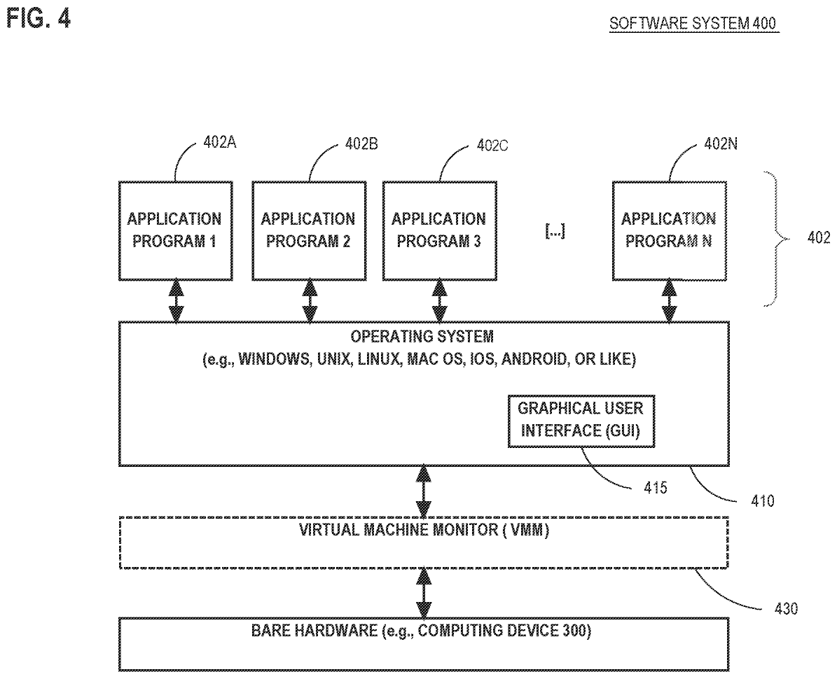

FIG. 4 is a block diagram of a basic software system 400 that may be employed for controlling the operation of computing system 300. Software system 400 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 400 is provided for directing the operation of computing system 300. Software system 400, which may be stored in system memory (RAM) 306 and on fixed storage (e.g., hard disk or flash memory) 310, includes a kernel or operating system (OS) 410.

The OS 410 manages low-level aspects of computer operation, including managing execution of processes, memory allocation, file input and output (I/O), and device I/O. One or more application programs, represented as 402A, 402B, 402C . . . 402N, may be “loaded” (e.g., transferred from fixed storage 310 into memory 306) for execution by the system 400. The applications or other software intended for use on computer system 300 may also be stored as a set of downloadable computer-executable instructions, for example, for downloading and installation from an Internet location (e.g., a Web server, an app store, or other online service).

Software system 400 includes a graphical user interface (GUI) 415, for receiving user commands and data in a graphical (e.g., “point-and-click” or “touch gesture”) fashion. These inputs, in turn, may be acted upon by the system 400 in accordance with instructions from operating system 410 and/or application(s) 402. The GUI 415 also serves to display the results of operation from the OS 410 and application(s) 402, whereupon the user may supply additional inputs or terminate the session (e.g., log off).

OS 410 can execute directly on the bare hardware 420 (e.g., processor(s) 304) of computer system 300. Alternatively, a hypervisor or virtual machine monitor (VMM) 430 may be interposed between the bare hardware 420 and the OS 410. In this configuration, VMM 430 acts as a software “cushion” or virtualization layer between the OS 410 and the bare hardware 420 of the computer system 300.

VMM 430 instantiates and runs one or more virtual machine instances (“guest machines”). Each guest machine comprises a “guest” operating system, such as OS 410, and one or more applications, such as application(s) 402, designed to execute on the guest operating system. The VMM 430 presents the guest operating systems with a virtual operating platform and manages the execution of the guest operating systems.

In some instances, the VMM 430 may allow a guest operating system to run as if it is running on the bare hardware 420 of computer system 300 directly. In these instances, the same version of the guest operating system configured to execute on the bare hardware 420 directly may also execute on VMM 430 without modification or reconfiguration. In other words, VMM 430 may provide full hardware and CPU virtualization to a guest operating system in some instances.

In other instances, a guest operating system may be specially designed or configured to execute on VMM 430 for efficiency. In these instances, the guest operating system is “aware” that it executes on a virtual machine monitor. In other words, VMM 430 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
detecting a plurality of distinct multidimensional points in an original plurality of multidimensional points that contains duplicates;
increasing, based on duplicates in the original plurality of multidimensional points, a respective observed frequency of each distinct multidimensional point in the plurality of distinct multidimensional points;
generating, based on a distinct multidimensional point of the plurality of distinct multidimensional points, a reconstruction of the distinct multidimensional point by a reconstructive model;
increasing, based on said increasing said observed frequency of the distinct multidimensional point, a scaled error of the reconstruction of the distinct multidimensional point;
increasing, based on the scaled error of the reconstruction of the distinct multidimensional point, accuracy of the reconstructive model;
wherein the method is performed by one or more computers.

2. The method of claim 1 further comprising training the reconstructive model with a training corpus that consists of the plurality of distinct multidimensional points.

3. The method of claim 1 further comprising generating a batch that represents more multidimensional points than the batch contains.

4. The method of claim 1 wherein each multidimensional point in the original plurality of multidimensional points represents a respective textual command.

5. The method of claim 4 wherein said detecting the plurality of distinct multidimensional points comprises normalization of whitespace or decapitalization of letters.

6. The method of claim 4 wherein said detecting the plurality of distinct multidimensional points comprises decreasing a numeric precision.

7. The method of claim 4 wherein:
the textual commands represented by the original plurality of multidimensional points are database statements;
said accuracy of the reconstructive model comprises anomaly detection accuracy.

8. The method of claim 1 wherein the original plurality of multidimensional points contains at least a hundred times as many multidimensional points as the plurality of distinct multidimensional points.

9. The method of claim 1 wherein said increasing the accuracy of the reconstructive model comprises applying stochastic gradient descent to a denoising autoencoder.

10. The method of claim 1 further comprising the reconstructive model inferring without using a distance measurement.

11. One or more non-transitory computer-readable media storing instructions that, when executed by one or more processors, cause:
detecting a plurality of distinct multidimensional points in an original plurality of multidimensional points that contains duplicates;
increasing, based on duplicates in the original plurality of multidimensional points, a respective observed frequency of each distinct multidimensional point in the plurality of distinct multidimensional points;
generating, based on a distinct multidimensional point of the plurality of distinct multidimensional points, a reconstruction of the distinct multidimensional point by a reconstructive model;
increasing, based on said increasing said observed frequency of the distinct multidimensional point, a scaled error of the reconstruction of the distinct multidimensional point;
increasing, based on the scaled error of the reconstruction of the distinct multidimensional point, accuracy of the reconstructive model.

12. The one or more non-transitory computer-readable media of claim 11 wherein the instructions further cause training the reconstructive model with a training corpus that consists of the plurality of distinct multidimensional points.

13. The one or more non-transitory computer-readable media of claim 11 wherein the instructions further cause generating a batch that represents more multidimensional points than the batch contains.

14. The one or more non-transitory computer-readable media of claim 11 wherein each multidimensional point in the original plurality of multidimensional points represents a respective textual command.

15. The one or more non-transitory computer-readable media of claim 14 wherein said detecting the plurality of distinct multidimensional points comprises normalization of whitespace or decapitalization of letters.

16. The one or more non-transitory computer-readable media of claim 14 wherein said detecting the plurality of distinct multidimensional points comprises decreasing a numeric precision.

17. The one or more non-transitory computer-readable media of claim 14 wherein:
the textual commands represented by the original plurality of multidimensional points are database statements;
said accuracy of the reconstructive model comprises anomaly detection accuracy.

18. The one or more non-transitory computer-readable media of claim 11 wherein the original plurality of multidimensional points contains at least a hundred times as many multidimensional points as the plurality of distinct multidimensional points.

19. The one or more non-transitory computer-readable media of claim 11 wherein said increasing the accuracy of the reconstructive model comprises applying stochastic gradient descent to a denoising autoencoder.

20. The one or more non-transitory computer-readable media of claim 11 wherein the instructions further cause the reconstructive model inferring without using a distance measurement.
